(19) United States
(12) Patent Application Publication
(10) Pub. No.: US 2014/0075018 A1
(43) Pub. Date: Mar. 13, 2014

(54) Systems and Methods of Audience Measurement

(71) Applicant: UMBEL CORPORATION, Austin, TX (US)

(72) Inventors: Higinio O. Maycotte, Austin, TX (US); Meredith Maycotte, Austin, TX (US); Nick Goggans, Austin, TX (US); Troy Lanier, Austin, TX (US); Travis Turner, Austin, TX (US); Jason Orr, Austin, TX (US)

(73) Assignee: Umbel Corporation, Austin, TX (US)

(21) Appl. No.: 13/850,779

(22) Filed: Mar. 26, 2013

Related U.S. Application Data
(60) Provisional application No. 61/699,725, filed on Sep. 11, 2012.

(51) Int. Cl. H04L 29/08

(52) U.S. Cl. CPC H04L 67/22
USPC 709/224

(57) ABSTRACT

A particular method includes receiving, at a computing device including a processor, a first event signal that includes a first browser identifier and first information indicative of a first interaction with respect to a media property. The method also includes determining that the first browser identifier corresponds to a particular user and associating the first event signal with a user profile of the particular user. The method further includes receiving a second event signal that includes a second browser identifier that is different from the first browser identifier and second information indicative of a second interaction with respect to the media property. The method includes determining that the second browser identifier corresponds to the particular user and associating the second event signal with the user profile.

### CROSS-REFERENCE TO RELATED APPLICATIONS

The present application claims priority from commonly owned U.S. Provisional Patent Application No. 61/699,725 filed Sep. 11, 2012, the content of which is expressly incorporated herein by reference in its entirety.

### BACKGROUND

Audience measurement can provide advertisers and publishers insight regarding how many people are viewing and/or listening to media content. For example, the Nielsen Company performs television audience measurement to determine which television channels and broadcasters attract the most viewers in various target demographics. Such ratings are often used by television executives to determine the price of television advertisements, what television programs should be renewed for another season, and what television programs should be cancelled. Similarly, Arbitron is a company that collects listener data for radio audiences. Data collected by Arbitron is published in radio industry periodicals and by the Radio Research Consortium. For print-based sources, such as newspapers and magazines, audience measurement is typically based on readership (e.g., number of subscriptions).
Internet-based consumption of media content is becoming increasingly popular. However, due to the distributed nature of consumers and Internet-enabled devices, audience measurement for such content may be difficult. Moreover, the Internet supports simultaneous delivery of audio, video, and textual content, which renders television-only, radio-only, and print-only measurement systems insufficient.

### SUMMARY

Systems and methods of audience measurement are disclosed. The techniques described herein may enable a measurement system to track user interactions with various media properties including interactions made using different devices. Audience measurements may be performed across various media formats including audio, video, textual, and game content accessible via the Internet. User identification information, such as social networking profiles and e-mail addresses, may be used to associate interactions with people that are part of the audience. An audience of a particular property (e.g., a website) may be segmented based on various demographic, social, and/or behavioral factors. Audience profiles of multiple properties may also be aggregated, enabling a publisher to evaluate audience characteristics over multiple properties. Audience profiles may be used to generate various quantitative and qualitative metrics that provide insight into audience interests and tendencies. In contrast to existing audience measurement techniques, which primarily deal with the “how many” and “how much” of an audience, the disclosed techniques may enable an improved understanding of “who” (i.e., the actual people) underlying the “how many” and “how much.”

In a particular embodiment, a method includes receiving, at a computing device including a processor, a first event signal that includes a first browser identifier and first information indicative of a first interaction with respect to a media property. The method also includes determining that the first browser identifier corresponds to a particular user and associating the first event signal with a user profile of the particular user. The method further includes receiving a second event signal that includes a second browser identifier that is different from the first browser identifier and that includes second information indicative of a second interaction with respect to the media property. The method includes determining that the second browser identifier corresponds to the particular user and associating the second event signal with the user profile.

In another particular embodiment, a method includes receiving, at a computing device including a processor, a first event signal that includes a first browser identifier and first information indicative of a first interaction with respect to a media property. The method also includes determining that the first browser identifier corresponds to a particular user and associating the first event signal with a user profile of the particular user. The method further includes receiving a second event signal that includes a second browser identifier and second information indicative of a second interaction with respect to the media property. The method includes associating the second event signal with the user profile in response to determining that the second browser identifier matches the first browser identifier.

In another particular embodiment, a method includes generating an interface at a computing device including a processor. The interface is generated based on an audience profile of an audience of a media property. The interface represents a plurality of interests of the audience using a plurality of first arcs of a circle. Each of the plurality of first arcs has a length corresponding to a proportion of a corresponding interest relative to the plurality of interests. The method also includes receiving a selection of a particular first arc of the plurality of first arcs that represents a particular interest of the plurality of interests. The method further includes, in response to the selection, updating the interface to represent a plurality of sub-interests of the particular interest using a plurality of second arcs of a second circle. Each of the plurality of second arcs has a length corresponding to a proportion of a corresponding sub-interest relative to the plurality of sub-interests.

### BRIEF DESCRIPTION OF THE DRAWINGS

FIG. 1 is a diagram to illustrate a particular embodiment of a system of audience measurement;

FIG. 2 is a diagram to illustrate another particular embodiment of a system of audience measurement;

FIG. 3 is a diagram to illustrate a particular embodiment of linking browser identifiers and user profile creation at the system of FIG. 1 and/or the system of FIG. 2;

FIG. 4 is a diagram to illustrate a particular embodiment of a data hierarchy associated with the system of FIG. 1 and/or the system of FIG. 2;

FIG. 5 is a screenshot to illustrate a particular embodiment of an overview report generated by the system of FIG. 1 and/or the system of FIG. 2;

FIG. 6 is a screenshot to illustrate a particular embodiment of audience segmentation;

FIG. 7 is a screenshot to illustrate a particular embodiment of a demographics report generated by the system of FIG. 1 and/or the system of FIG. 2;

FIG. 8 is a screenshot to illustrate a particular embodiment of an interests report generated by the system of FIG. 1 and/or the system of FIG. 2;

FIG. 9 is a screenshot to illustrate a particular embodiment of a geography report generated by the system of FIG. 1 and/or the system of FIG. 2;

FIG. 10 is a screenshot to illustrate a particular embodiment of a persona report generated by the system of FIG. 1 and/or the system of FIG. 2;

FIG. 11 is a screenshot to illustrate a particular embodiment of a site analytics report generated by the system of FIG. 1 and/or the system of FIG. 2;

FIG. 12 is a screenshot to illustrate a particular embodiment of a second degree audience report generated by the system of FIG. 1 and/or the system of FIG. 2;

FIG. 13 is a screenshot to illustrate a particular embodiment of a social network and influence report generated by the system of FIG. 1 and/or the system of FIG. 2;

FIG. 14 is a screenshot to illustrate a particular embodiment of a digital signal interface generated by the system of FIG. 1 and/or the system of FIG. 2;

FIG. 15 is a screenshot to illustrate a particular embodiment of the interface of FIG. 14 in response to a drill-down selection;

FIG. 16 is a flowchart to illustrate a particular embodiment of a method of associating browser identifiers to a user profile;

FIG. 17 is a flowchart to illustrate a particular embodiment of a method of generating and segmenting an audience profile; and

FIG. 18 is a flowchart to illustrate a particular embodiment of a method of generating and updating the interface of FIGS. 14-15.

### DETAILED DESCRIPTION

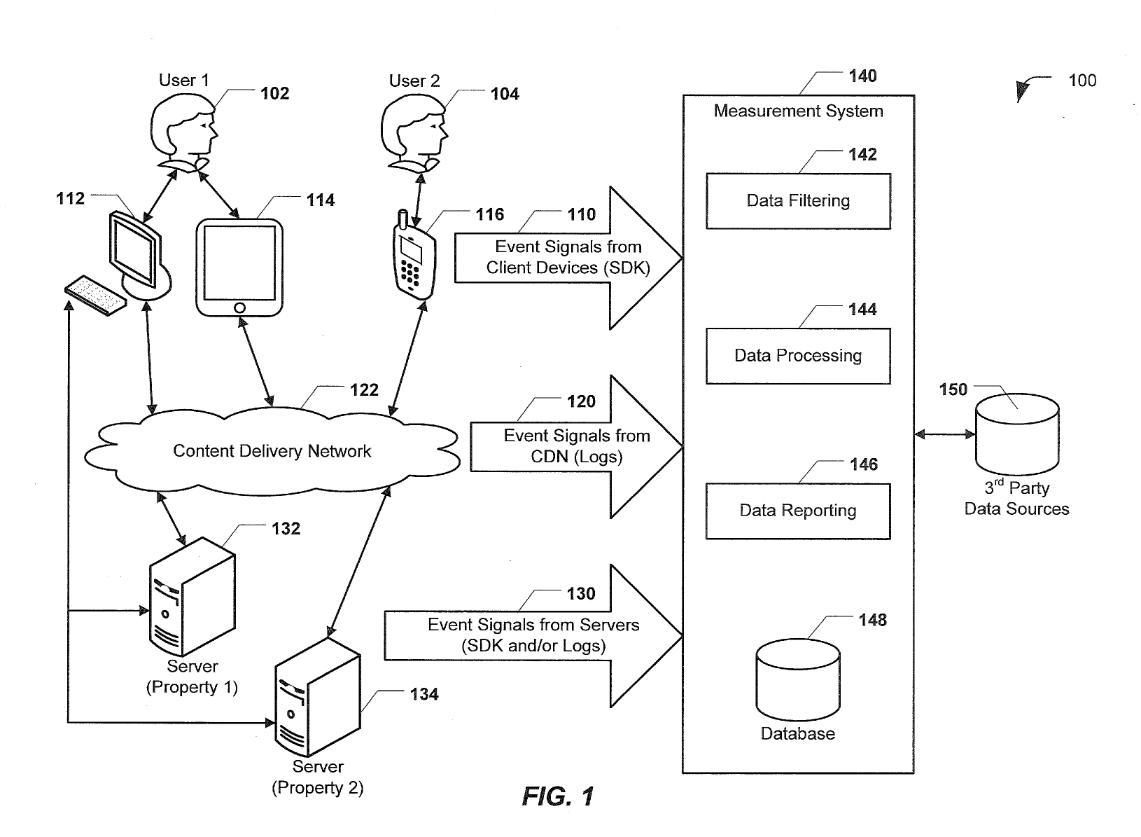

FIG. 1 is a diagram to illustrate a particular embodiment of a system of audience measurement and is generally designated 100. A measurement system 140 may be communicatively coupled to one or more user devices (e.g., illustrative user devices 112, 114, and 116), to one or more content delivery networks (CDNs) (e.g., illustrative CDN 122), and to one or more servers (e.g., illustrative servers 132 and 134). The measurement system 140 may be implemented using one or more computing devices (e.g., servers). For example, such computing devices may include one or more processors or processing logic, memories, and network interfaces. The memories may include instructions executable by the processors to perform various functions described herein. The network interfaces may include wired and/or wireless interfaces operable to enable communication to local area networks and/or wide area networks (e.g., the Internet).

The user devices 112-116 may be associated with various users. For example, the desktop computing device 112 and the tablet computing device 114 may be associated with a first user 102, and the mobile telephone device (e.g., smartphone) 116 may be associated with a second user 104. In a particular embodiment, the user devices 112-116 may execute applications that are operable to access media properties (e.g., via the servers 132-134). For example, the user devices 112-116 may include applications developed using a mobile software development kit (SDK) that includes support for audience measurement functions. To illustrate, when the SDK-based applications interact with the servers 132-134, the applications may generate first event signals 110 that are transmitted by the user devices 112-116 to the measurement system 140. The first event signals 110 may include information identifying specific interactions by the users 102-104 via the user devices 112-116 (e.g., what action was taken at a media property, when the action was taken, for how long the action was taken, etc.). The event signals 110 may also include an identifier, such as a browser identifier (browser ID) generated by the SDK. In a particular embodiment, browser identifiers are unique across software installations and devices. For example, a first installation of a SDK-based application at the desktop computing device 112 and a second installation of the same SDK-based application at the tablet computing device 114 may use different browser IDs, even though both installations are associated with the same user 102. In another particular embodiment, Browser IDs may remain consistent until applications or web browsers are “reset” (e.g., caches/cookies are cleared).

The user devices 112-116 may access content provided by the servers 132-134 directly or via the CDN 122. The CDN 122 may provide distributed, load-balanced access to audio, video, graphics, and web pages associated with the media properties corresponding to the servers 132-134. For example, the CDN 122 may include geographically distributed web servers and media servers that serve Internet content in a load-balanced fashion. The CDN 122 may send second event signals 120 to the measurement system 140. The second event signals 120 may include information identifying interactions with media properties and browser IDs provided to the CDN 122 by the user devices 112-116 and/or the servers 132-134. For example, the second event signals 120 may include CDN logs or data from CDN logs.

In the embodiment of FIG. 1, the first server 132 is associated with a first media property (e.g., a first website) and the second server 134 is associated with a second media property (e.g., a second website). The media properties may be controlled by the same entity or by different entities. The servers 132-134 may send third event signals 130 to the measurement system 140. The third event signals 130 may include information identifying interactions with the media properties and browser IDs provided by the user devices 112-116 during communication with the servers 132-134 (e.g., communication via hypertext transfer protocol (HTTP), transport control protocol/internet protocol (TCP/IP), or other network protocols).

In a particular embodiment, the third event signals 130 may include server logs or data from server logs. Alternately, or in addition, the third event signals 130 may be generated by SDK-based (e.g., web SDK-based) applications executing at the servers 132-134, such as JavaScript embedded into web pages hosted by the servers 132-134.

The first event signals 110 from the user devices 112-116 and the second event signals 120 generated by the CDN 122 may be considered “first-party” event signals. The third event signals 130 from the servers 132-134 may be considered “third-party” event signals. First party event signals may be considered more trustworthy and reliable than third party event signals, because of the possibility that third party event signals could modified by media property owners prior to transmission to the measurement system 140.

The measurement system 140 may include a data filtering module 142, a data processing module 144, and a data reporting module 146. In a particular embodiment, each of the modules 142-146 is implemented using instructions executable by one or more processors at the measurement system 140. The measurement system 140 may also include or otherwise have access to a database 148.

The data filtering module 142 may receive the event signals 110, 120, and 130. The data filtering module 142 may check the event signals 110, 120, and 130 for errors and may perform data cleanup operations when errors are found. In a particular embodiment, the data filtering module 142 may implement various application programming interfaces (APIs) for event signal collection and inspection. The data filtering module 142 may store authenticated/verified event signals in the database 148 or another event cache or archive.

The data processing module 144 may process event signals stored in the database 148 or in an event cache or archive. In a particular embodiment, the data processing module 144 may process events based on rules and policies defined by an audience measurement entity (e.g., an owner/vendor of the measurement system 140).

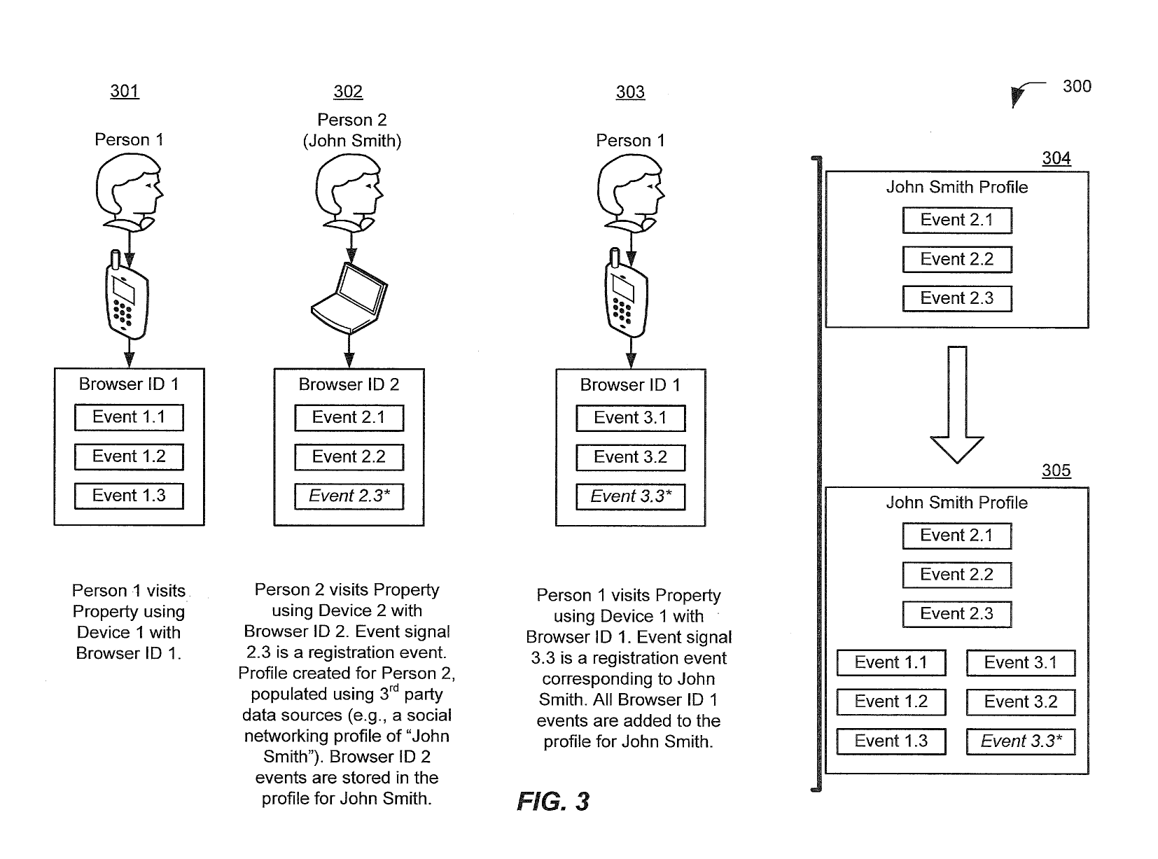

The data processing module 144 may also associate received event signals (and interactions represented thereby) with user profiles of users, as further described with reference to FIG. 3. For example, when an event signal having a particular browser ID is a social networking registration event (e.g., when a user logs into a website using a Facebook® account, a Twitter® account, or some other social networking account), the data processing module 144 may retrieve a corresponding social networking profile or other user profile data from third party data sources 150. Facebook® is a registered trademark of Facebook, Inc. of Menlo Park, Calif. Twitter® is a registered trademark of Twitter, Inc. of San Francisco, Calif.

It will be appreciated that interactions that were previously associated only with the particular browser ID (i.e., “impersonal” alphanumeric data) may be associated with an actual person (e.g., John Smith) after retrieval of the social networking profile or user profile. Associating interactions with individuals may enable qualitative analysis of the audiences of media properties. For example, if John Smith is a fan of a particular sports team, the measurement system 140 may indicate that at least one member of the audience of the first media property (corresponding to the first server 132) or the second media property (corresponding to the server 134) is a fan of the particular sports team. When a large percentage of a media property's audience shares a particular characteristic or interest, the media property may use such information in selecting and/or generating advertising or content. User profiles (e.g., a profile of the user John Smith) and audience profiles (e.g., profiles for the media properties associated with the servers 132-134) may be stored in the database 148. An audience profile for a particular media property may be generated by aggregating the user profiles of the individual users (e.g., including John Smith) that interacted with the particular media property. Audience profiles may be generated using as few as one or two user profiles, although any number of user profiles may be aggregated. In a particular embodiment, audience profiles may be updated periodically (e.g., nightly, weekly, monthly, etc.), in response to receiving updated data for one or more users in the audience, in response to receiving a request for audience profile data, or any combination thereof.

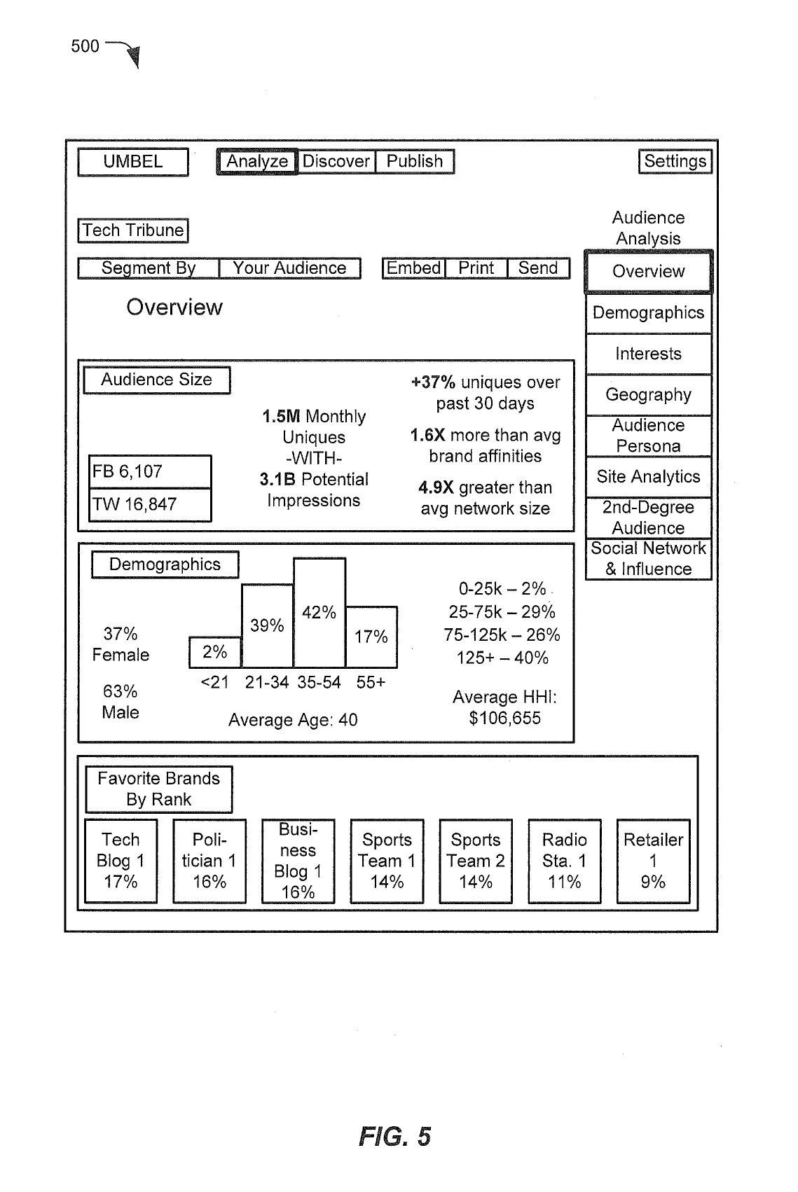

The data reporting module 146 may generate various interfaces based on the data stored in the database. Examples of such interfaces are further described with reference to FIGS. 5-15 and 18.

During operation, the users 102-104 may interact with the media properties corresponding to the servers 132-134. In response to the interactions, the measurement system 140 may receive one or more of the event signals 110, 120, and 130. Each event signal may include a unique identifier, such as a browser ID. The data filtering module 142 may verify the received event signals, and the data processing module 144 may determine whether any of the received event signals includes user identification information (e.g., a social networking registration token). In response to determining that a particular event signal includes user identification information, the data processing module 144 may associate the particular event signal and any other event signals having the same browser ID to a user profile of a corresponding user. If a user profile for the user does not exist, the data processing module 144 may create a user profile to be stored in the database 148 and may populate the user profile with information from the third party data sources 150. For example, the data processing module 144 may retrieve and store data from one or more social network profiles of the user. The data may include demographic information associated with the user (e.g., a name, an age, a geographic location, a marital/family status, a homeowner status, etc.), social information associated with the user (e.g., social networking activity of the user, social networking friends/likes/interests of the user, etc.), and other types of data.

The data reporting module 146 may generate interfaces based on the data stored in the database 148. For example, the data reporting module 146 may generate reports based on an audience profile of a media property, where the audience profile is based on aggregating user profiles of users that interacted with the media property. To illustrate, the data reporting module 146 may generate an overview interface indicating demographic attributes of the audience as a whole (e.g., a percentage of audience members that are male or female, percentages of audience members in various age brackets, percentages of audience members in various income bracket, most common audience member cities/states of residence, etc.). The overview interface may also indicate social attributes of the audience as a whole (e.g., the most popular movies, sports teams, etc. amongst members of the audience). An example of an overview interface is further described with reference to FIG. 5. Audience profiles may also be segmented and/or aggregated with other audience profiles, as further described herein.

The system of FIG. 1 may thus enable audience measurement and analysis based on data (e.g., event signals) received from various sources, where the data is generated in response to user interactions with websites, web pages, audio items, video items, games, and/or text associated with various media properties. In a particular embodiment, the measurement system 100 may also receive event signals based on measurements (e.g., hardware measurements) made at a device. For example, an event signal from the tablet computing device 114 or the mobile telephone device 116 may include data associated with a hardware measurement at the tablet computing device 114 or the mobile telephone device 116, such as an accelerometer or gyroscope measurement indicating an orientation, a tilt, a movement direction, and/or a movement velocity of the tablet computing device 114 or the mobile telephone device 116. The system 100 of FIG. 1 may also link interactions with user profiles of users. This may provide information of “how many” viewers and “how long” the viewers watched a particular video (e.g., as in current television rating measurement systems), and also “who” watched the particular video (e.g., demographic, social, and behavioral attributes of the viewers).

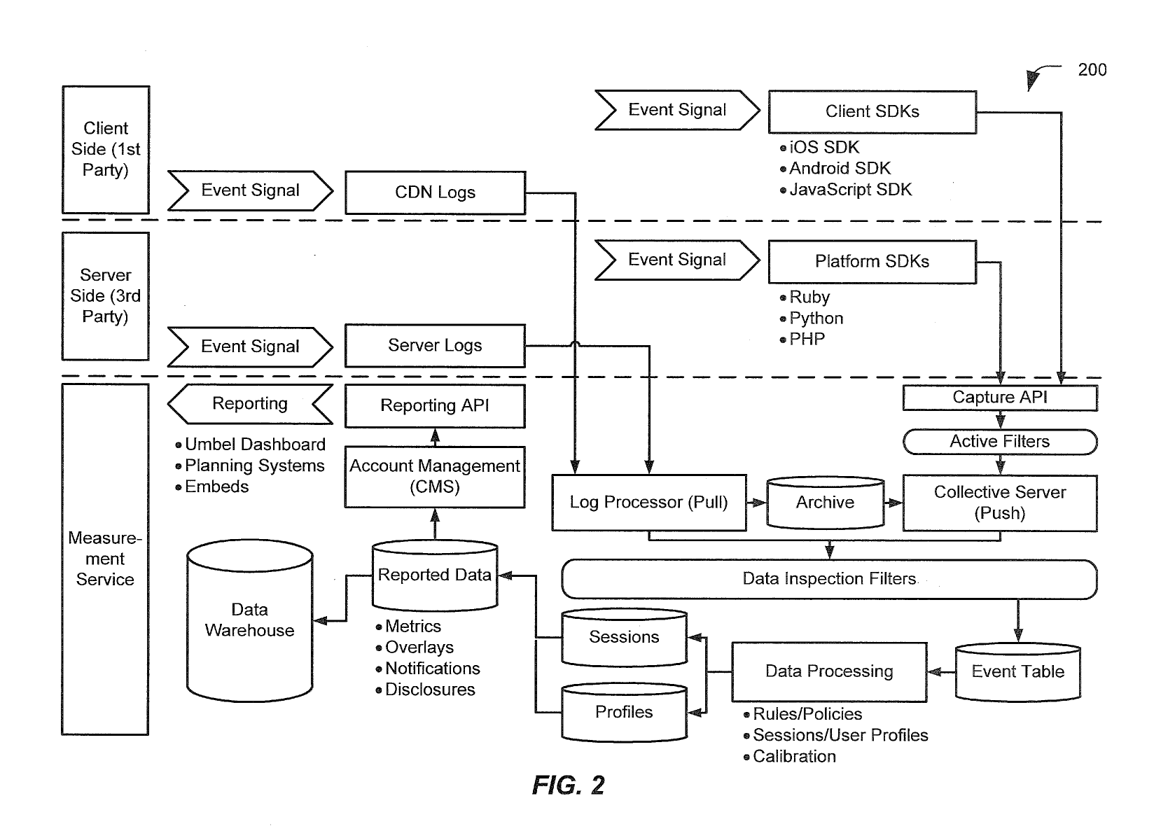

FIG. 2 is a diagram to illustrate another particular embodiment of a system 200 of audience measurement. As shown in FIG. 2, a measurement service (e.g., running at the measurement system 140 of FIG. 1) may receive first party (e.g., client side) event signals from CDN logs and from applications developed via client SDKs (e.g., iOS®, Android®, and/or JavaScript SDKs). iOS® is a registered trademark of Apple Inc. of Cupertino, Calif. Android® is a registered trademark of Google Inc. of Mountain View, Calif. The measurement service may also receive third party (e.g., server side) event signals from server logs and from applications developed via platform SDKs (e.g., Ruby, Python, and/or PHP: Hypertext Preprocessor (PHP) SDKs).

Event signals received via SDKs may be provided to one or more active filters (e.g., the data filtering module 142 of FIG. 1) via a capture API, as shown in FIG. 2. The active filters may provide the event signals to a push-based collection server, which stores the event signals in an archive. Event signals received via CDN logs and server logs may be provided to a pull-based log processor, which stores the received event signals in the archive. One or more data inspection filters (e.g., the data filtering module 142 of FIG. 1) may inspect the archived event signals and create/modify event tables that represent the event signals. A data processing module (e.g., the data processing module 144 of FIG. 1) may process the event table(s) and associate the various events to sessions and profiles (e.g., user profiles). The data processing module may use defined rules and policies and may perform data calibration operations.

The session and profile data may be used to generate reported data that is stored in a data warehouse. The reported data may include an aggregate of all data for a media property (e.g., event data and information related to all users that have interacted with the media property). The reported data may include or be used to generate one or more metrics, one or more overlays, one or more notifications, and/or one or more disclosures that are computed based on the output of the data processing module. In a particular embodiment, the reported data may also include external data that is received from one or more external data sources (e.g., the third party data sources 150). To illustrate, external data from a market research company may indicate that 8% of adults in the Boston, Mass. area are likely to own a particular type of automobile. An overlay may apply this external data to an individual user profile to determine the likelihood that a user owns the particular type of automobile. An overlay may also apply the external data to an audience profile to determine a likelihood and number of audience members owning the particular type of automobile. Information from such overlays may be used by the media property to select and price advertising and/or drive new content generation (e.g., to add advertisements and/or articles regarding the particular type of automobile or automobiles in general).

An account management module may provide the reported data to a reporting API (e.g., the data reporting module 146 of FIG. 1) that generates various reporting interfaces, such as an audience measurement dashboard, planning system interfaces, and items that maybe embedded into existing documents, reports, and communications.

The system 200 of FIG. 2 may thus capture demographic and behavioral data about users of websites and applications, transform the captured data into metrics, enable segmenting of audience information based on the data and metrics, and report aggregate information about such segments. Advantageously, the system 200 of FIG. 2 may provide information about a particular segment as a whole and may suggest other subsets or segments of the audience that may be similar to the particular segment.

To support the various event capturing and reporting functions described with reference to FIGS. 1-2, client side software and capture software may be provided to media properties. For example, client side software may be provided to an owner of a web page or application so that the software can be embedded into the web page or application. Once embedded, the software may generate and send event signals to an audience measurement system (e.g., the measurement system 140 of FIG. 1 or the system 200 of FIG. 2). The event signals may be used in various ways, including to gather information about individual users from third party sources. Client side software may include JavaScript on web pages and an SDK for application development. As described above, social registration may also be used by the measurement system. For example, when a social registration occurs, the measurement system may query, on the media property's behalf, the corresponding social registration provider to collect data about the user. This data collection may be performed in a timely manner and at scale (e.g., because the social registration may have an associated validity/expiration time).

Capture software may receive, parse, and store data in the form of a log file or a data object. The data may be used to calculate metrics and generate reporting interfaces, as described herein. For example, the metrics may include industry standard metrics regarding audio, video, application, and game consumption. Social media metrics that are not standardized by industry may also be created. Advantageously, a cross-media metric may be calculated to unify media consumption across multiple types of media (e.g., audio, video, game, text, and online social behavior). The described techniques may create reports that include side-by-side presentations of both existing industry metrics as well as cross-media and social behavior metrics.

A particular metric enabled by the described techniques is a consumability metric that defines whether the electronic delivery of media (e.g., content or advertising) was actually consumed. An example of media not being consumed includes, but is not limited to, a video that is playing off-screen and therefore not actually being seen. Based on such metrics, the measurement system may calculate a recommended advertising cost per impression (CPM) for a particular audience or subset (e.g., segment) thereof. The measurement system may also enable a client (e.g., a property owner) to search for and build segments of an audience that meet a particular CPM criteria. The measurement system may automatically search for and recommend particular segments to a client. The measurement system may also calculate a recommended price per person (RPPP) for a particular audience or subset (e.g., segment) thereof.

FIG. 3 is a diagram to illustrate a particular embodiment of linking browser identifiers and of user profile creation at the system 100 of FIG. 1 and/or the system 200 of FIG. 2 and is generally designated 300.

As shown at 301, a first person (designated “Person 1”) may visit a property (e.g., a website) using a first device (e.g. a mobile phone, designated “Device 1”). The mobile phone may be executing an SDK-based application that generates events and transmits a first browser ID (designated “Browser ID 1”) with the events during the visit. For example, three events, designated Event 1.1, Event 1.2, and Event 1.3 corresponding to the first browser ID may be generated based on interactions between the first person and the property.

Referring to 302, a second person (designated “Person 2”) may visit the property using a second device (e.g. a laptop computer, designated “Device 2”). The laptop computer may generate events and transmit a second browser ID (designated “Browser ID 2”) with the events during the visit. For example, three events, designated Event 2.1, Event 2.2, and Event 2.3 corresponding to the second browser ID may be generated based on interactions between the second person and the property. Event 2.3 may be a registration event that can be used to link the second browser ID to a user profile of a user. For example, the registration event may lead to a social networking profile of John Smith (e.g., the registration event may include a social network registration token that, when used with an API of the social network, results in retrieval of a web page corresponding to the social networking profile of John Smith). In response, the measurement system may create a profile for John Smith and add the events corresponding to the second browser ID to the profile, as shown at 304. The profile for John Smith may also be populated based on data from third party sources (e.g., the social networking website, etc.). The data from third party sources may also be cached for subsequent use (e.g., when adding events that correspond to a different browser ID to the profile for John Smith or during creation of a profile for John Smith with respect to a different media property).

Continuing to 303, the first person may revisit the property using the first device, generating three more events: Event 3.1, Event 3.2, and Event 3.3. Event 3.3 may be a second registration event that also corresponds to John Smith (e.g., the second registration event may include a second social network registration token that, when used with the API of the social network, results in retrieval of the web page corresponding to the social networking profile of John Smith). In response, the measurement system may conclude that the first person and the second person are actually the same person, i.e., John Smith. As shown at 305, the measurement system may thus add all events corresponding to the first browser ID to John Smith's profile. Further, because third party data for John Smith was previously cached, the third party data sources may not be queried for a second time, which may conserve network bandwidth at the measurement system.

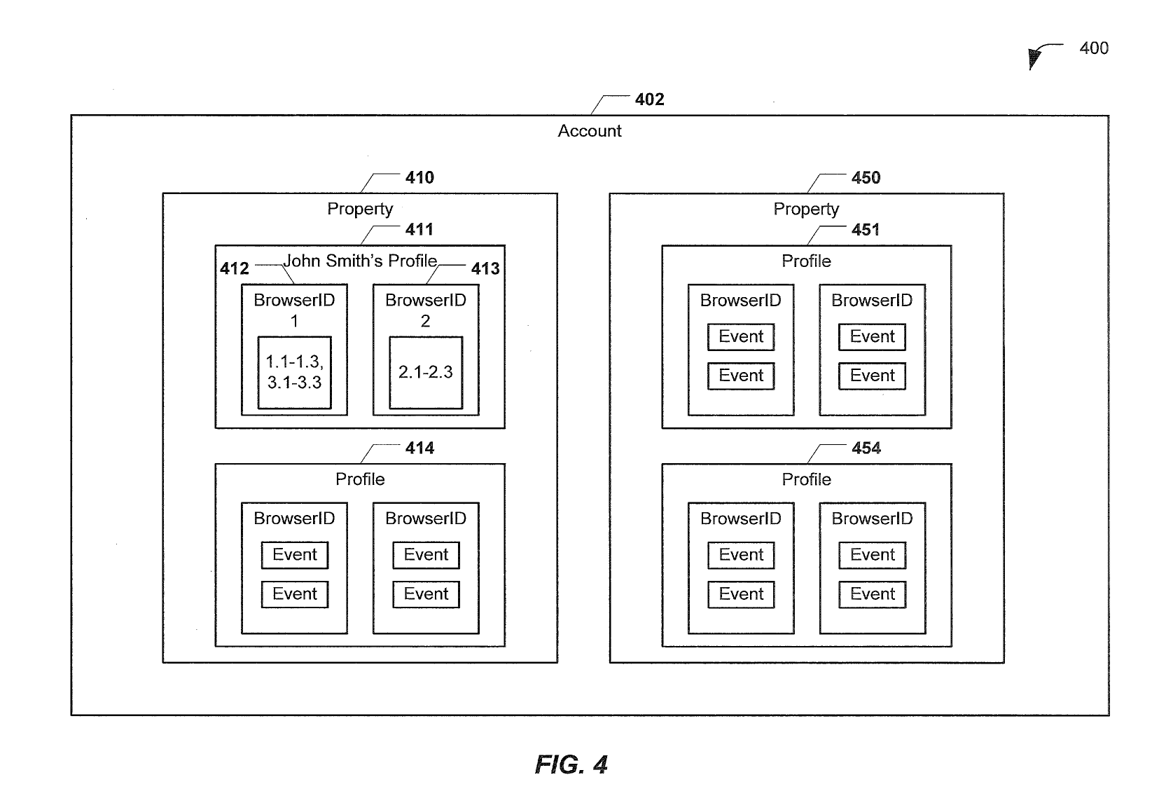

FIG. 4 is a diagram to illustrate a particular embodiment of a data hierarchy associated with the system 100 of FIG. 1 and/or the system 200 of FIG. 2 and is generally designated 400. A topmost level of the data hierarchy may correspond to client accounts. Each client account may correspond to an audience measurement client that owns one or more media properties. For example, an account 402 may include a first media property 410 and a second media property 450. In a particular embodiment, each media property 410, 450 is associated with a website, a uniform resource locator (URL), and/or a server (e.g., the servers 132-134 of FIG. 1).

Data stored for each media property may include user profiles of various users that interact with the media property. Thus, user profiles for the same user may be stored multiple times—once for each media property that the user interacts with. To illustrate, data for the first media property 410 may include a first user profile 411 and a second user profile 414. Each user profile 411, 414 may include events from various browser IDs that correspond to the user. For example, the first user profile 411 may be the profile for John Smith described with reference to FIG. 3 and may include events for Browser ID 1 412 and Browser ID 2 413. Events associated with Browser ID 1 412 may include Events 1.1-1.3 and Events 3.1-3.3. Events associated with Browser ID 2 413 may include Events 2.1-2.3. Similarly, data for the second media property 450 may include a first user profile 451 and a second user profile 454.

It will be appreciated that the data hierarchy shown in FIG. 4 may be used to perform various types of audience analysis and segmentation. For example, data from the first user profile 411 and the second user profile 414 may be aggregated to generate an audience profile for the first media property 410. Similarly, data from the first user profile 451 and the second user profile 454 may be aggregated to generate an audience profile for the second media property 450. Data from all four user profiles 411, 414, 451, and 454 may be aggregated to generate a multi-property client audience profile for the client account 402. It should be noted although the foregoing examples describe storing events corresponding to two browser IDs in a user profile, aggregating two user profiles to generate an audience profile for a media property, and aggregating two audience profiles to generate a client account profile, this is for illustration only. Any number of events corresponding to any number of browser IDs may be stored in or associated with a user profile, any number of user profiles may be aggregated to form an audience profile, and any number of audience profiles may be aggregated to generate a client account profile. By aggregating data corresponding to relatively large numbers of users, the described measurement system may generate rich data sets that can be used to generate various interfaces, such as the interfaces of FIGS. 5-15.

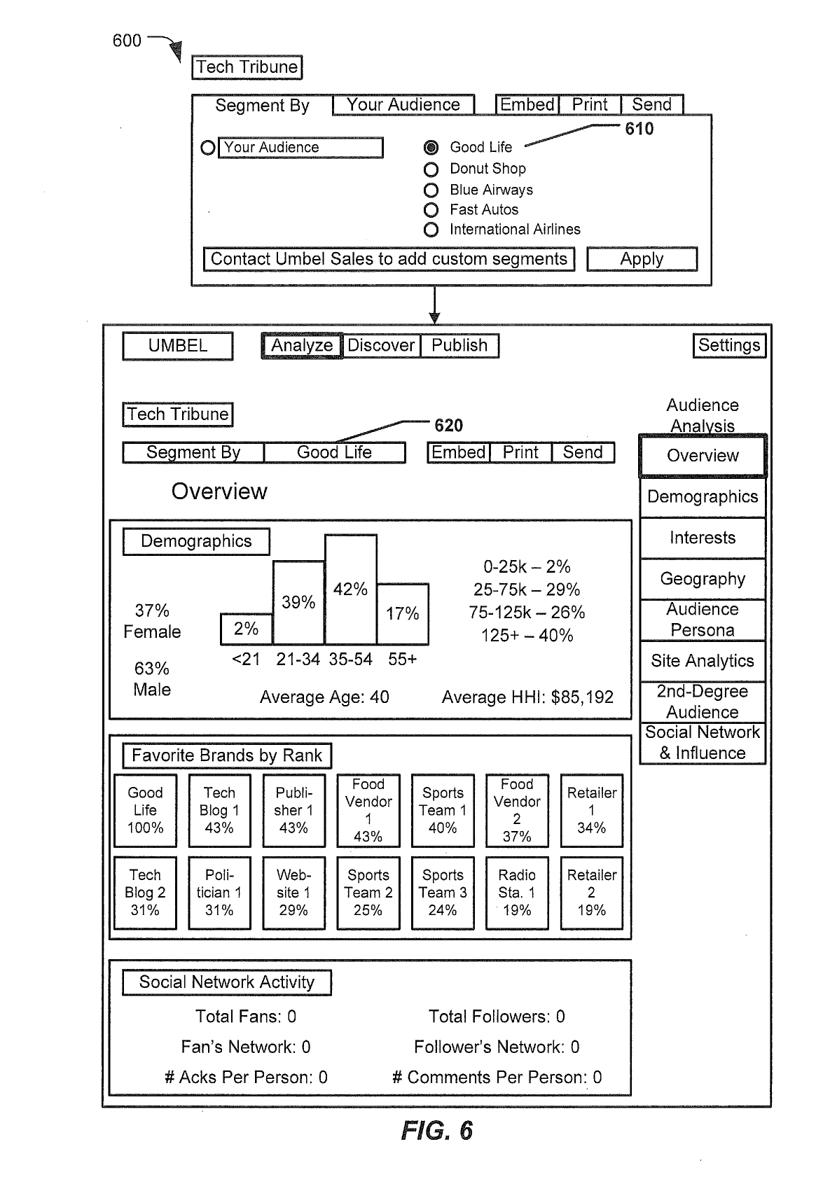

FIG. 5 is a screenshot to illustrate a particular embodiment of an overview report generated by the system 100 of FIG. 1 and/or the system 200 of FIG. 2 and is generally designated 500. In FIG. 5, the overview report is for a property called “Tech Tribune.” The overview report may include audience size information, demographic information, and interest/preference/brand association information. To illustrate, favorite brands of the audience of Tech Tribune include “Tech Blog 1,” “Politician 1,” “Business Blog 1,” “Sports Team 1,” “Sports Team 2,” “Radio Station 1,” and “Retailer 1.” The percentage associated with each brand may represent a percentage of the audience that demonstrates an affinity with the brand. Alternately, the percentage may represent a confidence level associated with a link between the brand and the audience as a whole. Data used to generate the overview interface of FIG. 5 and additional interfaces described with reference to FIGS. 6-15 may be retrieved from a database (e.g., the database 148 of FIG. 1). For example, the data may be stored in an audience profile, such as the audience profiles described with reference to the first media property 410 of FIG. 4 or the second media property 450 of FIG. 4.

FIG. 6 is a screenshot to illustrate a particular embodiment of audience segmentation and is generally designated 600. Whereas FIG. 5 illustrates overview information for the entire audience of Tech Tribune, FIG. 6 illustrates overview information for the audience segmented by “Good Life.” “Good Life” may represent a brand or a custom user-defined segmentation (e.g., based on one or more demographic, social, and/or behavioral characteristics of the audience). The demographic, favorite brands, and social network activity shown in FIG. 6 may thus relate to the members of the Tech Tribune audience that match the “Good Life” segmentation criteria.

As described herein, segmentation may be performed based on various criteria. A segment may include a subset of an audience as well as an audience itself. Clients may define segments of interest and view data regarding the specific segments. For example, the owner/publisher of Tech Tribune may select the “Good Life” segment, at 610, to view information about the “Good Life” segment of the Tech Tribune audience, as shown at 620. In a particular embodiment, an member of the Tech Tribune audience may be included in the “Good Life” segment if the audience member has “liked” social network web page for Good Life, discussed Good Life with someone else or via social networking messages, mentioned Good Life in a social networking update, befriended someone on the social network that is associated with Good Life, interacted with a Good Life content item or advertisement on the Tech Tribune website, etc.

The techniques described herein may enable a client to segment an audience based on industry standard filters (e.g., filtering an audience based on gender). The client may also filter the audience based on custom taxonomies that elaborate on established industry standards. For example, the audience measurement industry may have a “sports car” category, but the described techniques may enable a more elaborate category “sports cars seen in movies this year.” The available segmentation taxonomies may thus include white listed brands, brand categories, social behavior, analytics, and secondary audiences (e.g., social networking friends and followers of members of the audience).

Clients may create new segments using the various interfaces described herein. A segment may be a subset of the audience that satisfies a particular segmentation criteria. For example, a “Boston” segment of the Tech Tribune audience may include all members of the audience that reside in Boston, Mass. Clients may take various actions based on data about a segment. For example, the client may convert the segment into one that is tracked over time. The client may also combine the segment with another segment to create a new segment. The client may download contact information (e.g., e-mail addresses) of users within a segment (e.g., for targeted marketing purposes). The client may also initiate a process to create customized experiences for users within the segment. Customized experiences may include content and/or advertising delivery in websites and e-mails. Further, the client may request the measurement service to find other segments similar to the specified segment. It will be appreciated that predictive segmentation and search may notify a client (e.g., a media property owner or publisher) regarding a segment that the client was previously unaware of.

In a particular embodiment, a client may elect to be included in a universal panel so that the client can compare anonymized data about their properties, segments, and audiences against those of other members of the panel. The universal panel may be used by the measurement service to generate indexes and benchmarks. It should be noted that by siloing user data within a property and by anonymizing data in the universal panel, the measurement service may protect client and user privacy.

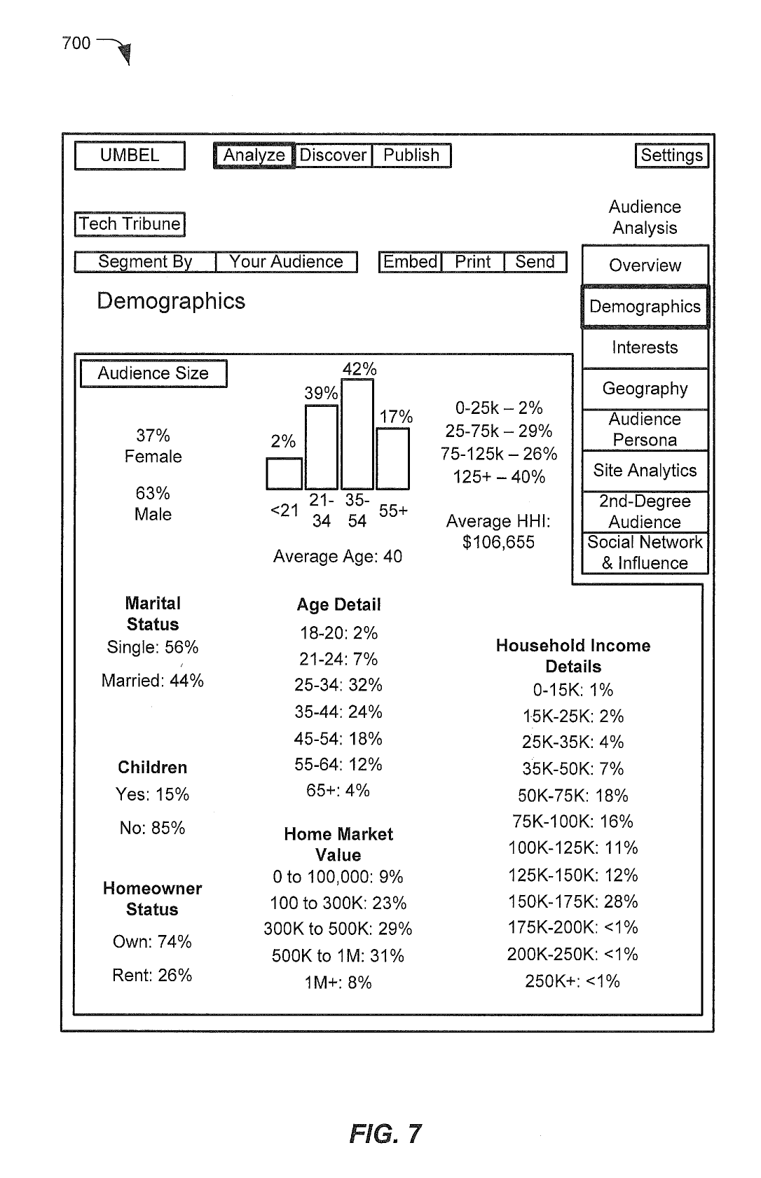

FIG. 7 is a screenshot to illustrate a particular embodiment of a demographics report generated by the system 100 of FIG. 1 and/or the system 200 of FIG. 2 and is generally designated 700. For example, as shown in FIG. 7, the audience of Tech Tribune is predominantly male, single, between the ages of 25-44, and owns a home.

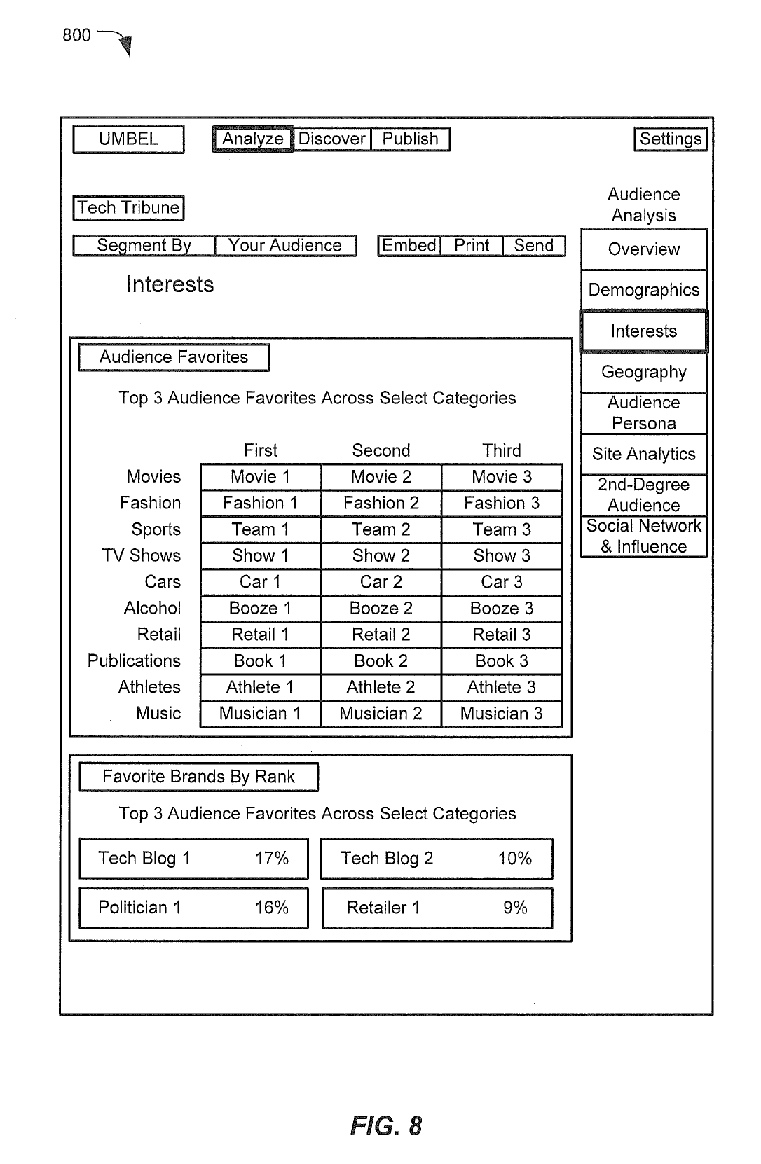

FIG. 8 is a screenshot to illustrate a particular embodiment of an interests report generated by the system 100 of FIG. 1 and/or the system 200 of FIG. 2 and is generally designated 800. The interests report may list first, second, and third choices of various audience favorites, as shown. The interests report may also list favorite brands by rank, as shown.

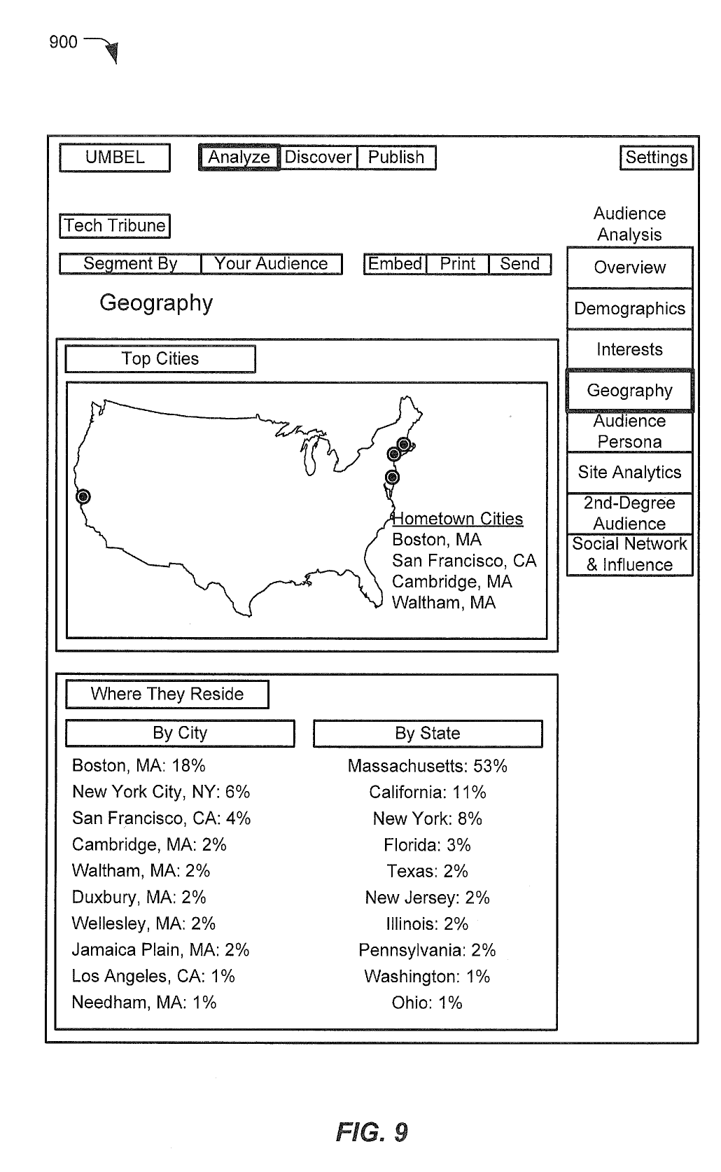

FIG. 9 is a screenshot to illustrate a particular embodiment of a geography report generated by the system 100 of FIG. 1 and/or the system 200 of FIG. 2 and is generally designated 900. As shown in FIG. 9, most of the Tech Tribune audience resides in the Boston, Mass. area.

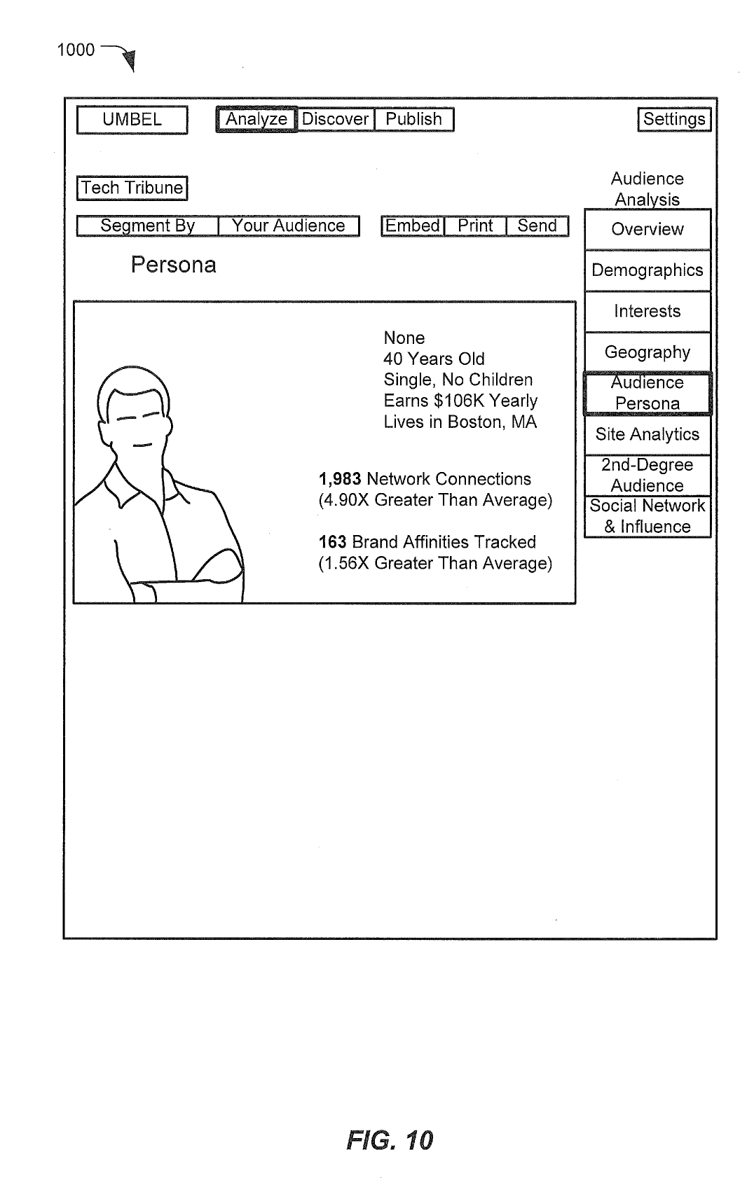

FIG. 10 is a screenshot to illustrate a particular embodiment of a persona report generated by the system 100 of FIG. 1 and/or the system 200 of FIG. 2 and is generally designated 1000. In the embodiment of FIG. 10, the persona for the Tech Tribune audience is 40 years sold, single, childless, earns $106,000 per year, lives in Boston, Mass., has 1,983 network connections, and has 163 brand affinities.

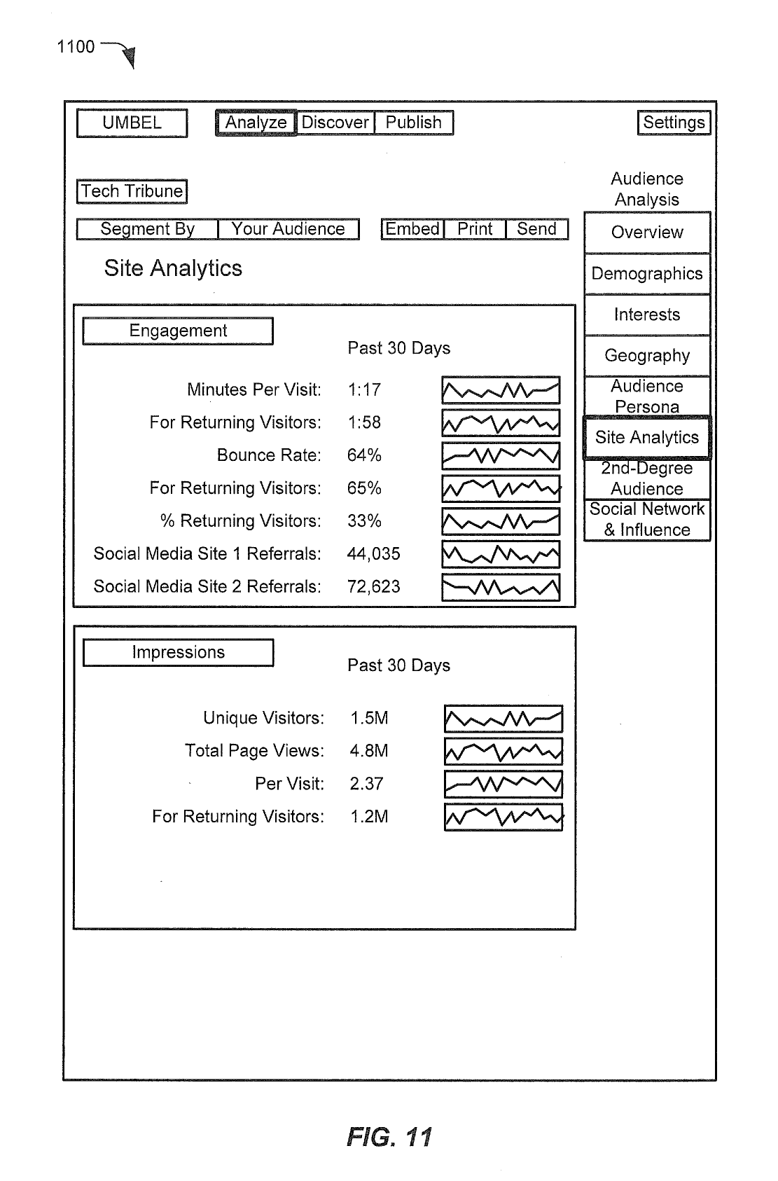

FIG. 11 is a screenshot to illustrate a particular embodiment of a site analytics report generated by the system 100 of FIG. 1 and/or the system 200 of FIG. 2 and is generally designated 1100. As shown in FIG. 11, site analytics may include, but are not limited to, engagement metrics (e.g., minutes per visit for new and returning visitors, bounce rate for new and returning visitors, percentage of returning visitors, and social network referrals) and impression metrics (e.g., unique visitors and total page views per visit and for returning visitors).

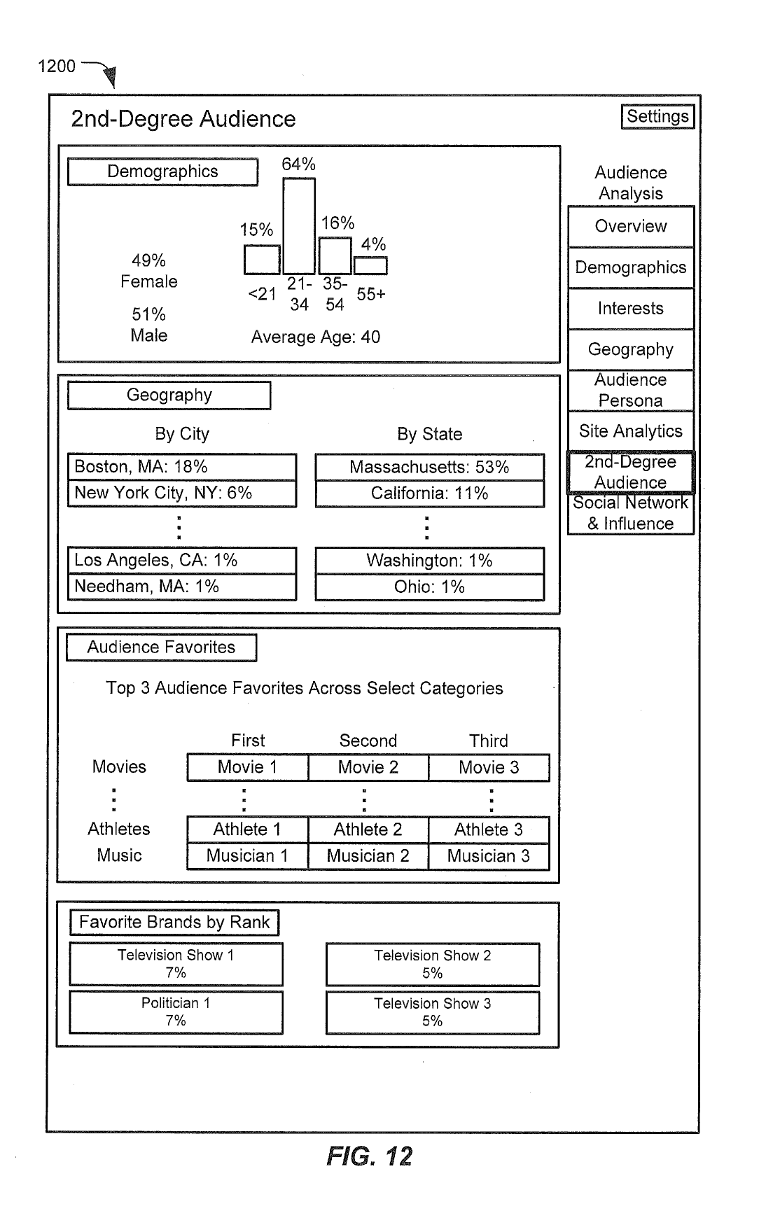

FIG. 12 is a screenshot to illustrate a particular embodiment of a second degree audience report generated by the system 100 of FIG. 1 and/or the system 200 of FIG. 2 and is generally designated 1200. For example, the second degree audience for Tech Tribune may include social network contacts of users that are in Tech Tribune's audience. As shown in FIG. 12, the second degree audience for Tech Tribune is almost evenly divided between males and females, in the 21-34 age bracket, and largely resides in Boston, Mass. Notably, however, the favorites of the second degree audience are different than the favorites of Tech Tribune's primary audience. A client may track (e.g., register for and receive updates for) a secondary audience segment and/or combine the secondary audience segment with other segments.

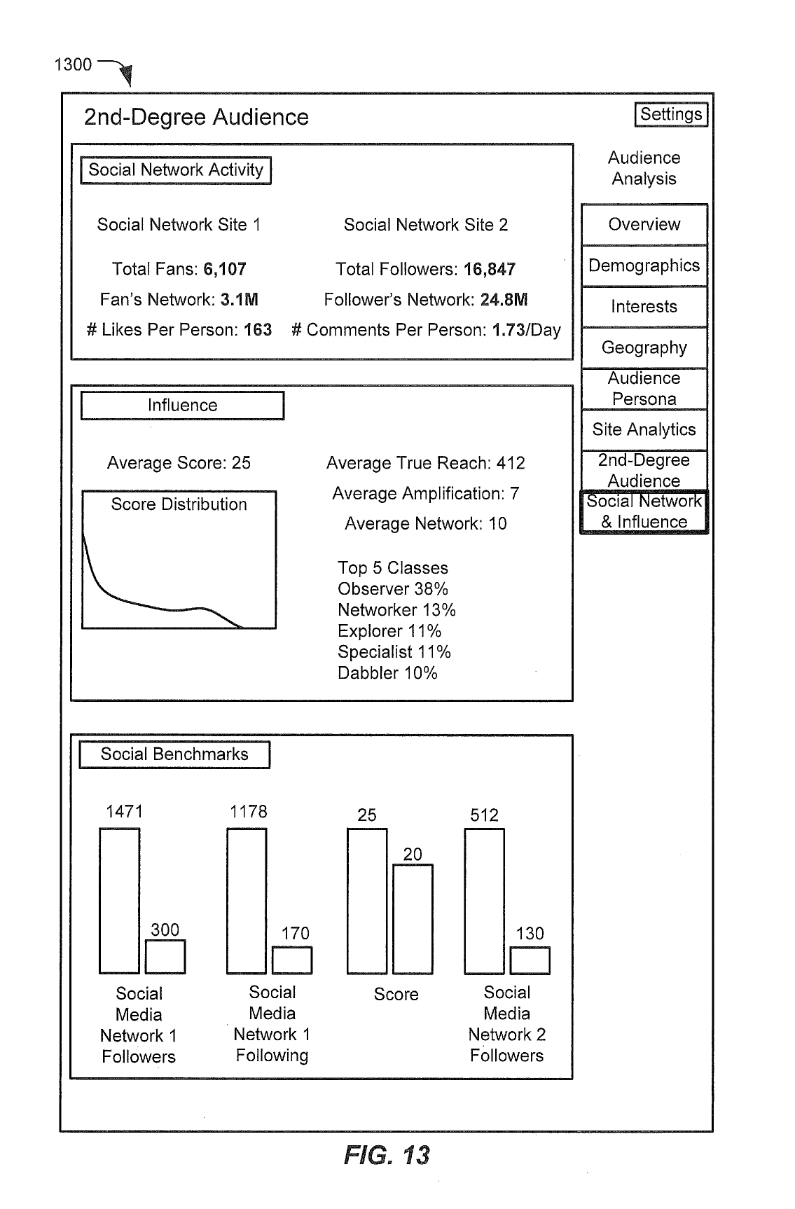

FIG. 13 is a screenshot to illustrate a particular embodiment of a social network and influence report generated by the system 100 of FIG. 1 and/or the system 200 of FIG. 2 and is generally designated 1300. The social network and influence report may include social networking characteristics, such as social network activity, influence, and social benchmarks. For example, as shown in FIG. 13, the audience of Tech Tribune is more active and has more influence than the Internet average.

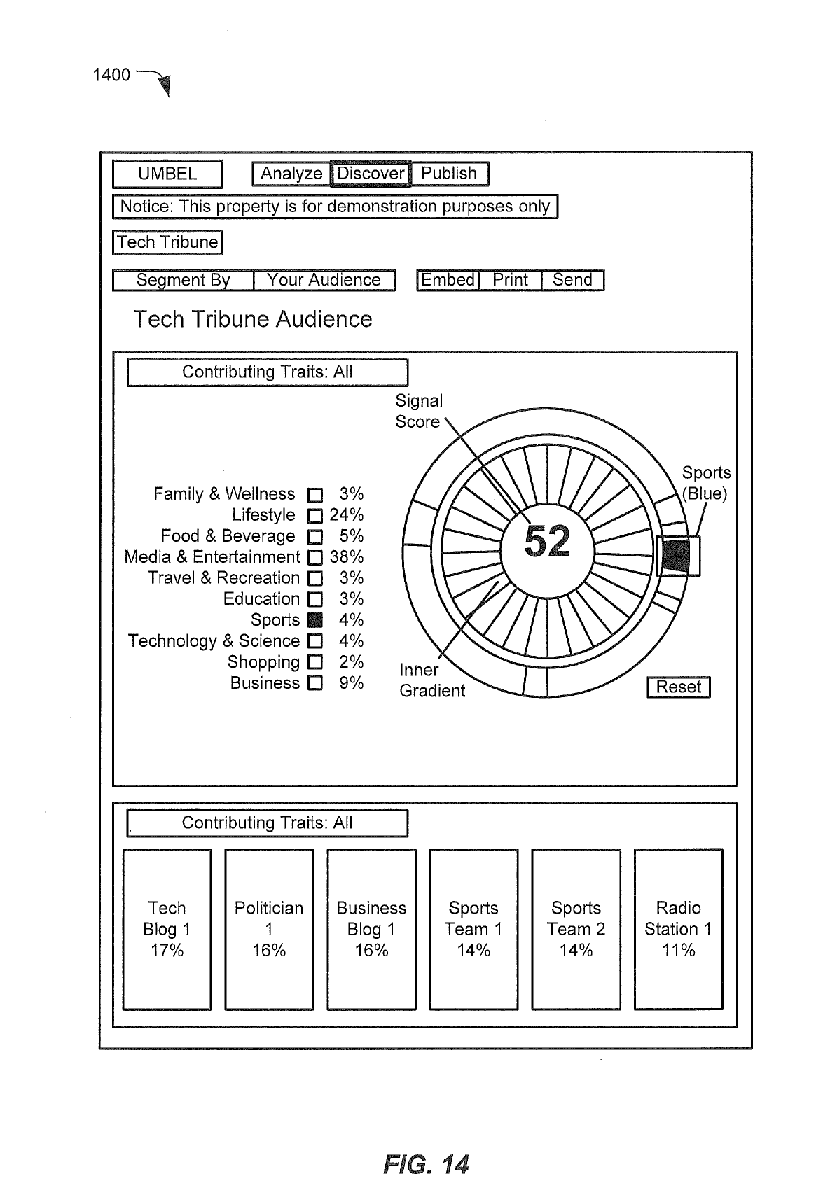

FIG. 14 is a screenshot to illustrate a particular embodiment of a digital signal interface generated by the system 100 of FIG. 1 and/or the system 200 of FIG. 2 and is generally designated 1400. In the embodiment of FIG. 14, the interface is represented using a “circular genome discovery wheel.” The circular genome discovery wheel may include various features.

For example, the circular genome discovery wheel may use radial length to represent relative importance of data. For example, as shown in FIG. 14, an arc corresponding to media and entertainment is largest, indicating that the audience of Tech Tribune has a largest category affinity to the media and entertainment category. The interface may also display contributing traits. For example, the highest contributing traits for the Tech Tribune audience as a whole are Tech Blog 1, Politician 1, Business Blog 1, Sports Team 1, Sports Team 2, and Radio Station 1.

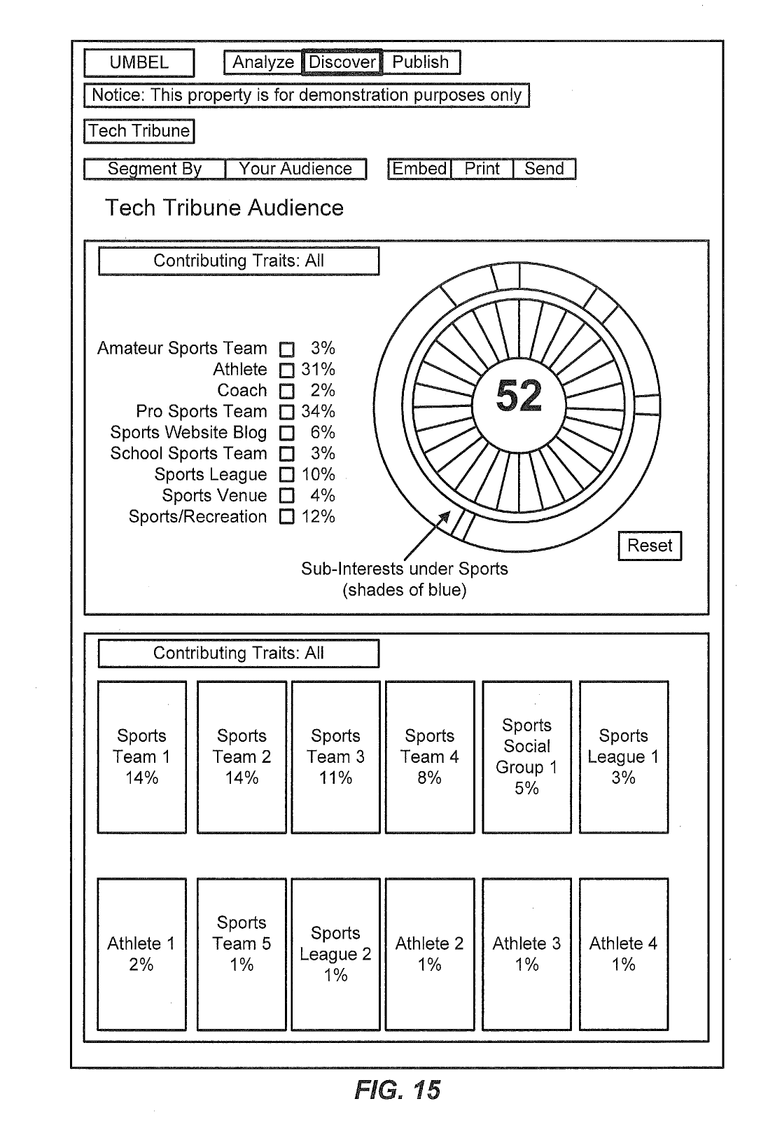

The category affinities displayed by the circular genome discovery wheel may be delineated by color. When a particular category is selected, shades of the color may be used to represent arcs corresponding to sub categories. For example, as shown in FIG. 15, in response to a drill-down selection of the blue sports category arc, various arcs that are represented using different shades of blue are used to show the relative importance of sports sub-categories (e.g., athlete, professional sports team, etc.). The contributing traits may also be dynamically updated to show contributing traits for the selected sports category. For example, the contributing traits for the selected sports category include various sports teams, leagues, and athletes, as shown. Sub-interests may also be selected to further drill down into the interest hierarchy. In a particular embodiment, the circular genome discovery wheel may include an inner circular gradient, as shown in FIG. 14. A relatively smooth gradation in the inner circle may represent a relatively connected audience.

The interface may also include a reset control, as shown in FIG. 15. The reset control may be operable to reset the circular genome discovery wheel to a topmost level of the interest hierarchy. For example, in response to the selection of the reset control, the interface of FIG. 15 may be replaced by or updated to reflect the interface of FIG. 14. It should be noted that although the example of FIGS. 14-15 illustrates the that the “Sports” circle of FIG. 15 replaces the top-level circle of FIG. 14, this is for example only. In a particular embodiment, a circle for a particular interest or sub-interest may be displayed alongside a top-level or previous level circle instead of being displayed in the same location as (e.g., on top of) the top-level or previous level circle.

The circular genome discovery wheel may include a digital signal score. For example, the digital signal score in FIGS. 14-15 is 52. The digital signal score may represent a number of event signals associated with the audience, a confidence of event signals associated with the audience, or any combination thereof.

In a particular embodiment, the digital signal score may be a value between 1 and 100, plotted on a bell curve. The digital signal score may indicate how much data and confidence is associated with a particular set of data. For example, a person's digital signal score may be an average of the person's Like Index (e.g., representing the person's social networking “likes”), Network Index (e.g., representing the person's social network and influence) and Action Index (e.g., representing action performed by the person). A particular web page's digital signal score may also be an average of the web page's Like Index, Network Index, and Action Index. For a property, the digital signal score may be an average of an Average Like Index (e.g., across users in the property's audience), an Average Network Index, and an Average Action Index of the property. For an aggregated property (e.g., a multi-property client audience), the average calculations may be performed across all user profiles of all properties in the aggregated property.

Social networks often enable users to be “fans” of a particular person, a particular brand (e.g., represented by a web page of the social network), etc. Fans of a particular person represented by a particular profile of the social network may be calculated as one or more of the number of people that “like” the particular person, the number of people who are friends with the particular person, and the number of people who share a “like” with the particular person. Fans of a brand represented by a particular web page of the social network may be calculated as one or more of a total number of fans of the web page, a number of fans in the measurement system universe, a number of fans selected via a measurement system filter, and a number of fans that have a particular “like.”

“Likes” may be measured by the Like Index, which may be a value between 1 and 100, plotted on a bell curve. Likes may be measured relative to the measurement system universe. For example, if person A and person B share fifty likes, it may be concluded that person A and person B are very similar. However, this may not be accurate (e.g., if person A has two thousand total likes and person B has fifty-one total likes). For an individual person, the Like Index may be calculated based on the total number of likes the person has, plotted on a bell curve where the extremes represent the people with the fewest and most likes in the measurement system universe. For a web page, the Like Index may be the average of the Like Indices of the fans of the web page. For a property, the Average Like Index may be the Like Index for all profiles divided by the number of profiles.

The Network Index may be a value between 1 and 100, plotted on a bell curve. The measurement system may use relative network sizes to estimate a potential reach of an individual person. Thus, as a person's Network Index increases, the audience exposed to that person's activity increases. For a person, the Network Index may be the number of friends the person has, plotted on a bell curve where the extremes represent the people with the fewest and most friends on the measurement system universe. For a web page, the Network Index may be the average of the Network Indices of the fans of the page. For a property, the Average Network Index of a property may be the Network Index for all user profiles associated with the property divided by the number of user profiles.

The Action Index may be a value between 1 and 100, plotted on a bell curve. Actions may generally indicate how engaged a person is. If a person has little activity, they are less likely to reach an audience when they engage with the property, irrespective of the size of their network. The Action Index may include data from a particular time period (e.g., the previous month) so that relatively current activity, not all past activity, is measured. For a person, the Action Index may be the number of times the person has posted a social networking status update or commented on someone else's updates, plotted on a bell curve where the extremes represent the people with the fewest and most such actions in the measurement system universe. For a web page, the Action Index may be the average of the Action Indices of the fans of the page. For a property, the Average Action Index may be the Action Index for all profiles divided by the number of profiles.

FIGS. 5-15 thus illustrate various interfaces that may be generated based on data collected by the measurement systems of FIGS. 1-2, including interfaces related to an audience of a property, a segment of the audience, an aggregated client audience that includes audiences of multiple properties associated with the client, etc. In a particular embodiment, the interfaces (or reports generated therefrom) may be embedded into web pages, sent via e-mail, etc. Thus, a client may register for and receive daily, weekly, monthly, etc. reports regarding audience profiles for the client's properties.

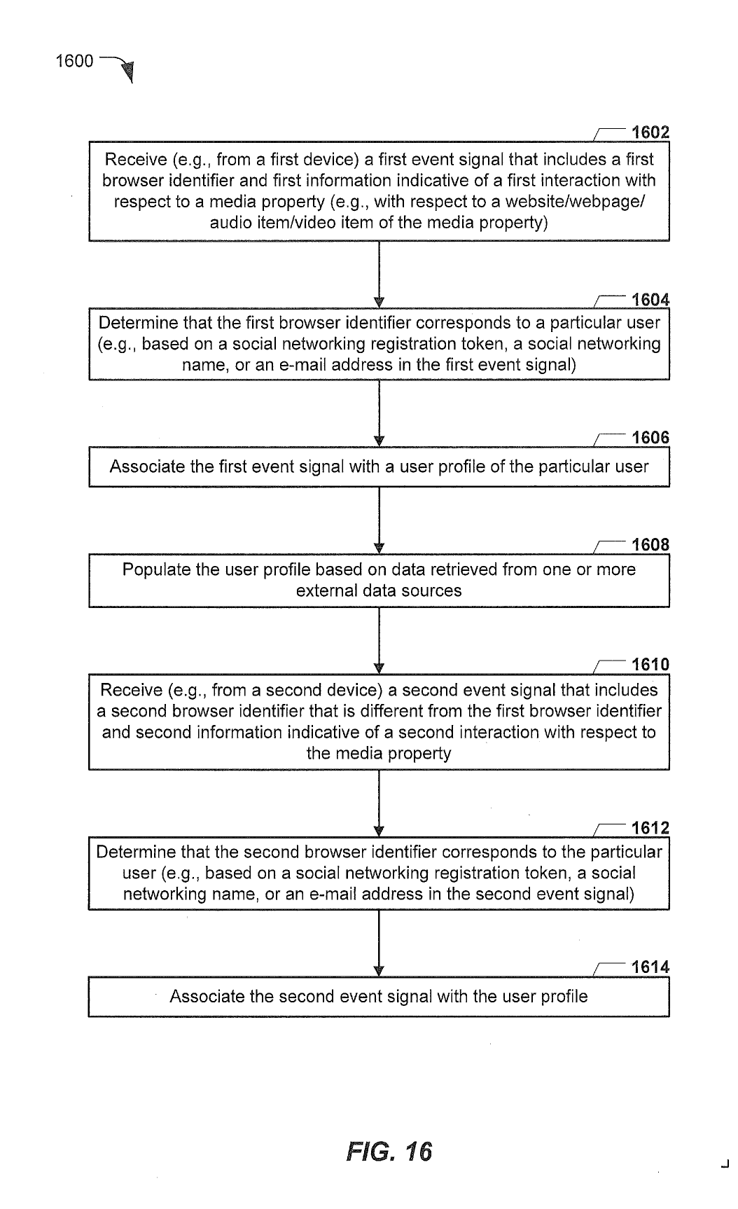

FIG. 16 is a flowchart to illustrate a particular embodiment of a method 1600 of associating browser identifiers to a user profile. In an illustrative embodiment, the method 1600 may be performed at the system 100 of FIG. 1 or the system 200 of FIG. 2 and may be illustrated with reference to FIG. 3.

The method 1600 may include receiving (e.g., from a first device) a first event signal that includes a first browser identifier and first information indicative of a first interaction with respect to a media property (e.g., with respect to a website/web page/audio item/video item/game of the media property), at 1602. For example, the first event signal may be one of the event signals 110, 120, or 130 of FIG. 1. The method 1600 may also include determining that the first browser identifier corresponds to a particular user (e.g., based on a social networking registration token, a social networking name, or an e-mail address in the first event signal), at 1604. The method 1600 may further include associating the first event signal with a user profile of the particular user, at 1606. For example, referring to FIGS. 1-3, a measurement system (e.g., the measurement system 140 of FIG. 1 or the system 200 of FIG. 2) may create a profile for John Smith and associate the “Browser ID 2” events (e.g., Events 2.1-2.3) with the profile of John Smith, as shown at 304. The method 1600 may include populating the user profile based on data retrieved from one or more external data sources, at 1608. For example, the measurement system may retrieve profile data for John Smith from third party sources (e.g., the third party data sources 150 of FIG. 1).

The method 1600 may include receiving (e.g., from a second device) a second event signal that includes a second browser identifier that is different from the first browser identifier and second information indicative of a second interaction with respect to the media property, at 1610. For example, the second event signal may be one of the event signals 110, 120, or 130 of FIG. 1. The method 1600 may also include determining that the second browser identifier corresponds to the particular user (e.g., based on a social networking registration token, a social networking name, or an e-mail address in the second event signal), at 1612. The method 1600 may further include associating the second event signal with the user profile, at 1614. For example, referring to FIG. 3, the measurement system may associate the Browser ID 1 events (e.g., Events 1.1-1.3 and 3.1-3.3) with the profile for John Smith, as shown at 305.

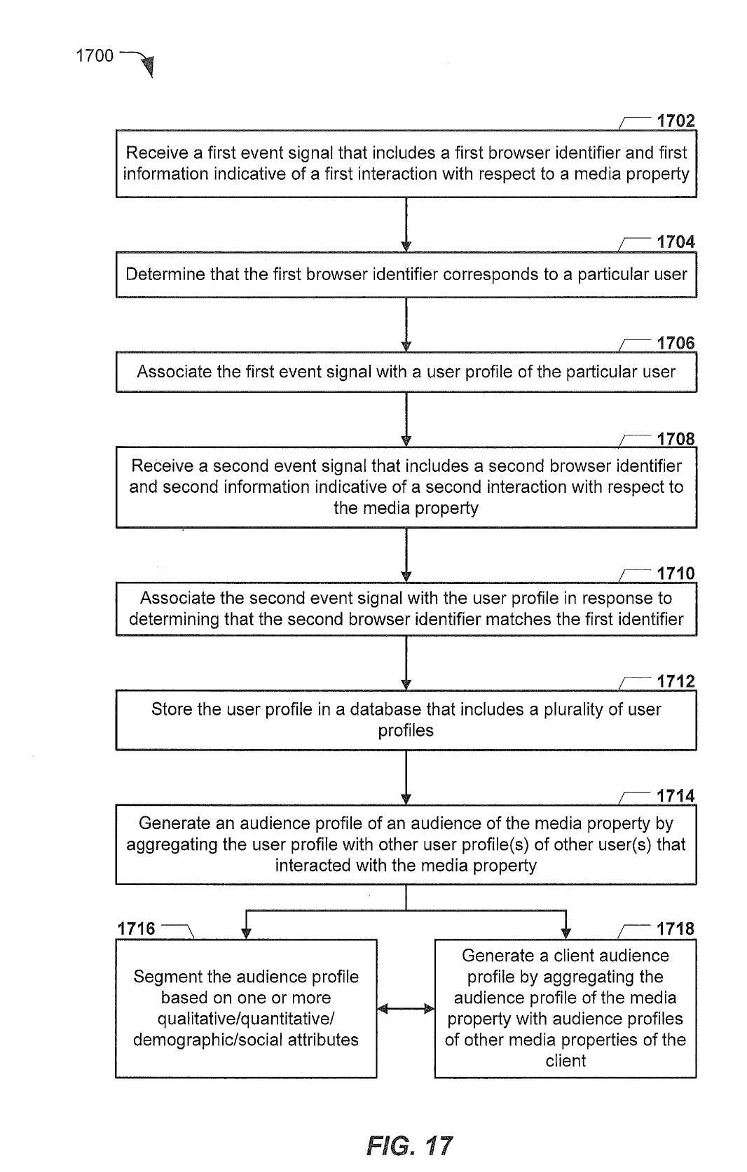

FIG. 17 is a flowchart to illustrate a particular embodiment of a method 1700 of generating and segmenting an audience profile. In an illustrative embodiment, the method 1700 may be performed at the system 100 of FIG. 1 or the system 200 of FIG. 2 and may be illustrated with reference to FIG. 3.

The method 1700 may include receiving a first event signal that includes a first browser identifier and first information indicative of a first interaction with respect to a media property, at 1702. The method 1700 may also include determining that the first browser identifier corresponds to a particular user, at 1704, and associating the first event signal with a user profile of the particular user, at 1706. For example, referring to FIGS. 1-3, the measurement system (e.g., the measurement system 140 of FIG. 1 or the system 200 of FIG. 2) may associate Browser ID 1 event signals with the user profile for John Smith, as shown at 304.

The method 1700 may include receiving a second event signal that includes a second browser identifier and second information indicative of a second interaction with respect to the media property, at 1708. The method 1700 may further include associating the second event signal with the user profile in response to determining that the second browser identifier matches the first identifier, at 1710. For example, referring to FIG. 3, the measurement system may associate any subsequently received event signals that include Browser ID 1 with the user profile for John Smith. The method 1700 may include storing the user profile in a database that includes a plurality of user profiles, at 1712. For example, the database may include the database 148 of FIG. 1, the sessions, profiles, reported data, or data warehouse of FIG. 2, or any combination thereof.

The method 1700 may also include generating an audience profile of an audience of the media property by aggregating the user profile with other user profile(s) of other user(s) that interacted with the media property, at 1714. Audience profiles may be updated periodically (e.g., nightly, weekly, monthly, etc.), in response to receiving updated data for one or more users in the audience, in response to receiving a request for audience profile data, or any combination thereof. The method 1700 may include segmenting the audience profile based on one or more qualitative, quantitative, demographic, and/or social attributes, at 1716. Alternately, or in addition, the method 1700 may include generating a client audience profile by aggregating the audience profile of the media property with audience profiles of other media properties of the client, at 1718.

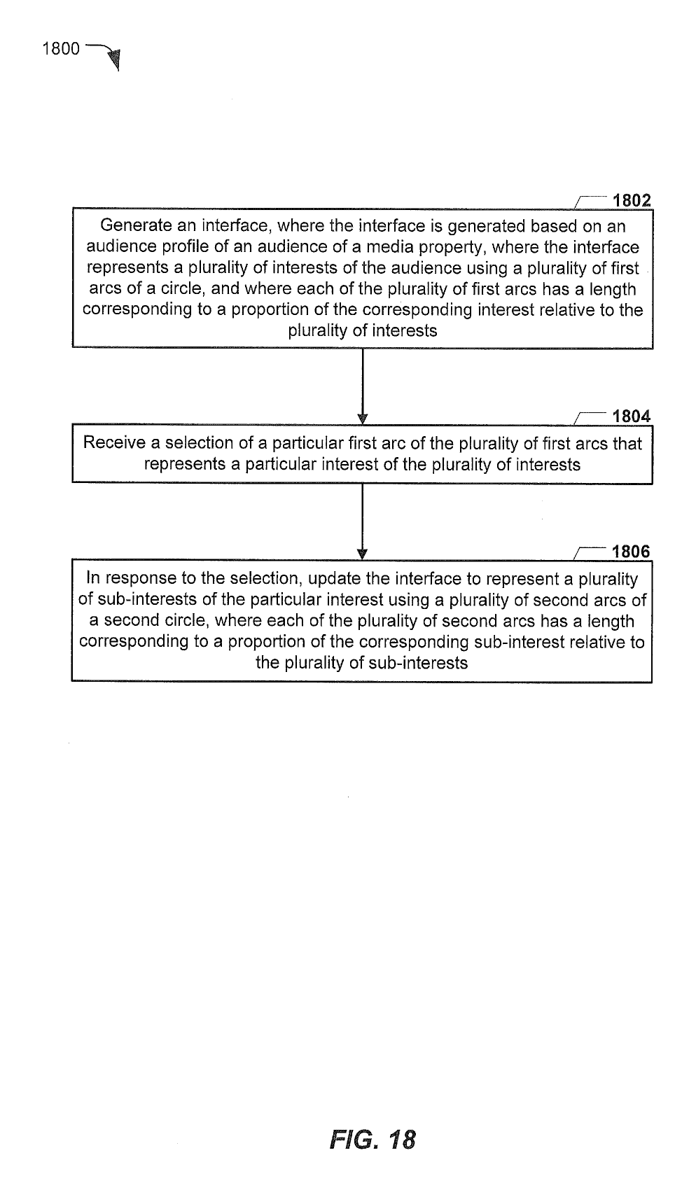

FIG. 18 is a flowchart to illustrate a particular embodiment of a method 1800 of generating and updating the interface of FIGS. 14-15. The method 1800 includes generating an interface, at 1802. The interface may be generated based on an audience profile of an audience of a media property, where the interface represents a plurality of interests of the audience using a plurality of first arcs of a circle. Each of the plurality of first arcs may have a length (e.g., radial length) corresponding to a proportion of the corresponding interest relative to the plurality of interests. In a particular embodiment, the taxonomy of interests is defined by the measurement system and/or by a client (e.g., a media property owner/publisher). The interests of each user in the audience may be determined based on the user's “likes” (e.g., the user “likes” a Boston sports team) who or what the user is a “fan” of (e.g., the user is a “fan” of the Boston sports team's social network profile page), and/or interactions of the user with respect to the media property (e.g., the user clicks on an advertisement for the Boston sports team on the media property or views an article about the Boston sports team on the media property). For example, referring to FIG. 14, the circular genome discovery wheel may be generated, where the arcs of the circular genome discovery wheel have lengths representing a relative interest level.

The method 1800 may also include receiving a selection of a particular first arc of the plurality of first arcs that represents a particular interest of the plurality of interests, at 1804. For example, referring to FIG. 14, a selection of the “Sports” arc may be received. The method 1800 may further include, in response to the selection, updating the interface to represent a plurality of sub-interests of the particular interest using a plurality of second arcs of a second circle, at 1806. Each of the plurality of second arcs may have a length corresponding to a proportion of the corresponding sub-interest relative to the plurality of sub-interests. For example, referring to FIG. 15, the circular genome discovery wheel may be updated to display arcs for the various sub-interests (e.g., Amateur Sports Team, Athlete, Coach, Professional Sports Team, etc.) of the selected “Sports” interest.

In accordance with various embodiments of the present disclosure, the methods, functions, and modules described herein may be implemented by software programs executable by a computer system. Further, in an exemplary embodiment, implementations can include distributed processing, component/object distributed processing, and parallel processing. Alternatively, virtual computer system processing can be constructed to implement one or more of the methods or functionality as described herein.

Particular embodiments can be implemented using a computer system executing a set of instructions that cause the computer system to perform any one or more of the methods or computer-based functions disclosed herein. A computer system may include a laptop computer, a desktop computer, a mobile phone, a tablet computer, a set-top box, a media player, or any combination thereof. The computer system may be connected, e.g., using a network, to other computer systems or peripheral devices. For example, the computer system or components thereof can include or be included within any one or more of the devices 112-116 of FIG. 1, the CDN 122, of FIG. 1, the servers 132-134 of FIG. 1, the measurement system 140 of FIG. 1, the third party data sources 150 of FIG. 1, the system 200 of FIG. 2, or any combination thereof. In a networked deployment, the computer system may operate in the capacity of a server or as a client user computer in a server-client user network environment, or as a peer computer system in a peer-to-peer (or distributed) network environment. The term “system” can include any collection of systems or sub-systems that individually or jointly execute a set, or multiple sets, of instructions to perform one or more computer functions.

In a particular embodiment, the instructions can be embodied in a non-transitory computer-readable or processor-readable medium. The terms “computer-readable medium” and “processor-readable medium” include a single medium or multiple media, such as a centralized or distributed database, and/or associated caches and servers that store one or more sets of instructions. The terms “computer-readable medium” and “processor-readable medium” also include any medium that is capable of storing a set of instructions for execution by a processor or that cause a computer system to perform any one or more of the methods or operations disclosed herein.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method comprising:
receiving, at a computing device comprising a processor, a first event signal that includes a first browser identifier and first information indicative of a first interaction with respect to a media property;
determining that the first browser identifier corresponds to a particular user;
associating the first event signal with a user profile of the particular user;
receiving a second event signal that includes a second browser identifier that is different from the first browser identifier and second information indicative of a second interaction with respect to the media property;
determining that the second browser identifier corresponds to the particular user; and
associating the second event signal with the user profile.

2. The method of claim 1, wherein the first interaction is performed via a first device associated with the particular user, wherein the second interaction is performed via a second device associated with the user, and wherein the first device is different from the second device.

3. The method of claim 2, wherein the first device and the second device each comprise a laptop computer, a desktop computer, a mobile phone, a tablet computer, a set-top box, a media player, or any combination thereof.

4. The method of claim 1, wherein the first interaction and the second interaction are performed with respect to a particular website, a particular web page, a particular audio item, a particular video item, a particular textual item, a particular game, or any combination thereof that is associated with the media property.

5. The method of claim 1, wherein the first event signal and the second event signal are each received from a content delivery network (CDN) log, a server log, an application associated with a mobile application software development kit (SDK), an application associated with a web SDK, or any combination thereof.

6. The method of claim 1, wherein the first event signal includes user identification information, and wherein determining that the first browser identifier corresponds to the particular user comprises determining that the user identification information is associated with the particular user.

7. The method of claim 6, wherein the user identification information comprises a social networking registration token, a social networking name, an e-mail address, or any combination thereof.

8. The method of claim 6, further comprising populating the user profile based on data based on the user identification information, the data retrieved from one or more external data sources based on the user identification information.

9. A method comprising:
receiving, at a computing device comprising a processor, a first event signal that includes a first browser identifier and first information indicative of a first interaction with respect to a media property;
determining that the first browser identifier corresponds to a particular user;
associating the first event signal with a user profile of the particular user;
receiving a second event signal that includes a second browser identifier and second information indicative of a second interaction with respect to the media property; and
associating the second event signal with the user profile in response to determining that the second browser identifier matches the first browser identifier.

10. The method of claim 9, further comprising storing the user profile in a database that includes a plurality of user profiles.

11. The method of claim 9, further comprising generating an audience profile of an audience of the media property, wherein generating the audience profile comprises aggregating the user profile with one or more other user profiles of other users that performed interactions with respect to the media property.

12. The method of claim 11, further comprising generating an interface representing the audience profile.

13. The method of claim 12, wherein the interface is operable to segment the audience profile based on one or more qualitative attributes, one or more quantitative attributes, one or more demographic attributes, one or more social attributes, or any combination thereof.

14. The method of claim 12, wherein the interface is operable to display demographics of the audience, interests of the audience, geography of the audience, a persona of the audience, analytics associated with interactions of members of the audience with the media property, a second degree audience, social networking characteristics of the audience, or any combination thereof.

15. The method of claim 11, wherein the media property is one of a plurality of media properties associated with a client, and further comprising aggregating the audience profile with at least one other audience profile associated with at least one other media property associated with the client to generate an aggregated multi-property client audience profile.

16. A method comprising:
generating an interface at a computing device comprising a processor, wherein the interface is generated based on an audience profile of an audience of a media property, wherein the interface represents a plurality of interests of the audience using a plurality of first arcs of a circle, and wherein each of the plurality of first arcs has a length corresponding to a proportion of a corresponding interest relative to the plurality of interests;
receiving a selection of a particular first arc of the plurality of first arcs that represents a particular interest of the plurality of interests; and
in response to the selection, updating the interface to represent a plurality of sub-interests of the particular interest using a plurality of second arcs of a second circle, wherein each of the plurality of second arcs has a length corresponding to a proportion of a corresponding sub-interest relative to the plurality of sub-interests.

17. The method of claim 16, wherein the particular first arc is represented using a particular color and wherein each of the plurality of second arcs is represented using a shade of the particular color.

18. The method of claim 16, wherein the interface includes a reset control operable to display the plurality of first arcs.

19. The method of claim 16, wherein the interface includes a signal score representing a number of event signals associated with the audience, a confidence of event signals associated with the audience, or any combination thereof.

20. The method of claim 19, wherein the interface is operable to display one or more corresponding audience traits associated with the particular interest in response to the selection of the particular first arc.
